(19) United States
(12) Patent Application Publication
(10) Pub. No.: US 2020/0321169 A1
(43) Pub. Date: Oct. 8, 2020

(54) Keycap for a Luminous Keyboard and the Method for Manufacturing the Same

(71) Applicant: Huizhou Guocheng Electronics Co., Ltd., Huizhou City (CN)

(72) Inventors: Qiang Xiao, Huizhou City (CN); Jia Chen, Huizhou City (CN); Xiangxu Gao, Huizhou City (CN); Liang Chen, Huizhou City (CN)

(21) Appl. No.: 16/397,696

(22) Filed: Apr. 29, 2019

(30) Foreign Application Priority Data
Apr. 2, 2019 (CN) 201910263287.X

(51) Int. Cl. H01H 13/14; H01H 13/02

(52) U.S. Cl. CPC H01H 13/14; H01H 13/023; H01H 2229/02; H01H 2229/044; H01H 2229/036; H01H 2219/054

(57) ABSTRACT

A keycap for a luminous keyboard comprises a base and a cap made of a transparent material. The base is provided with a first stage, and the top surface thereof is transparent. The cap covers the first stage, and is fixedly connected with the base. The cap is provided with a light-shielding layer, and the surface of which and opposite to the first stage is engraved with a light-transmitting area by laser. A manufacturing method for the same is described. Using the disclosed keycap and the manufacturing method thereof, the operator can accurately and quickly operate the keyboard in a dark environment, making the usage more convenient. As the light-transmitting area in the shape of characters or patterns is not likely to be rubbed or erased, the lifetime of the keycap is prolonged.

### FIELD OF THE INVENTION

The invention relates to the keyboard technology and, in particular, to a keycap for a luminous keyboard and the method for manufacturing the same.

### BACKGROUND OF THE INVENTION

Most of the existing single keycaps exhibit a monochromic color and cannot have a combination of different colors. Moreover, traditional keycaps are opaque. Therefore, users are unable to accurately identify the keycaps on the keyboard in a dark environment, seriously affecting the operation. The characters or patterns printed on the traditional keycaps can easily be rubbed away or get blurred, a great inconvenience to the users.

### SUMMARY OF THE INVENTION

In view of the foregoing, an objective of the invention is to provide a keycap for a luminous keyboard and the method of manufacturing the same.

The disclosed keycap for a luminous keyboard comprises a base and a cap made of a transparent material, wherein the base is provided with a first stage whose top surface is transparent, the cap covers the first stage and is fixedly connected to the base, the cap is provided with a light-shielding layer, and a light-transmitting area is engraved by laser on the side of the light-shielding layer opposite to the first stage.

The cap and the base are fixedly connected by dispensing or ultrasonic welding.

A light-shielding layer is provided on the inner surface of the cap.

A weakening layer for weakening light is formed on the surface of the light-shielding layer.

The outer surface of the cap is provided with a light-shielding layer and a wear-resistant layer, with the wear-resistant layer disposed on the light-shielding layer.

A weakening layer for weakening light is disposed between the outer surface of the cap and the light-shielding layer.

The top surface of the first stage on the base is provided with a light-transmitting hole.

The disclosed method of manufacturing the above-mentioned keycap includes the following steps:

S1: injection molding a cap using a transparent or translucent material, and injection molding a base having a first stage, with the top surface of the first stage being transparent;

S2: spraying a paint of white or other color on the inner surface of the cap, and then spraying a light-shielding paint of silver, black or some other light-shielding color on the inner surface of the cap, forming a light-shielding layer; or spraying a white primer for weakening light on the outer surface of the cap to form a weakening layer, and then spraying on the outer surface of the cap with a paint of silver, black or other light-shielding color, forming a light-shielding layer;

S3: removing part of the paint on the light-shielding layer by laser engraving according to a desired character or pattern, thereby forming a light-transmitting area in the shape of a character or pattern;

S4: spraying a paint of pearl white on the inner surface of the cap to form a weakening layer; or spraying a UV paint on the outer surface of the cap to form a wear-resistant layer; and

S5: covering the cap on the first stage of the base, and fixedly connecting the cover onto the base by dispensing or ultrasonic welding.

The first stage of the base is formed with an opening to form a light-transmitting hole.

Benefits of the invention are as follows. Using the disclosed keycap and the manufacturing method thereof, the user can accurately and quickly use the keyboard even in a dark environment. It is more convenient to use. The light-transmitting area of characters or patterns is less likely to be erased. This can extend the lifetime of the keycap. Moreover, the combination of the cap and the base is in a crystal shape, enhancing the visual effect of the entire keyboard. The keyboard looks more beautiful and comfortable, and feels better;

In addition, the light-shielding layer and the base of the cap can be set in different colors, so that the keycaps present multiple colors, rendering more abundant styles and more beautiful structures. This can satisfy the needs of different users and solves the problem of monochromic colors in conventional keycaps.

### BRIEF DESCRIPTION OF THE DRAWINGS

FIG. 1 is a three-dimensional view of the keycap according to an embodiment of the invention;

FIG. 2 is a three-dimensional exploded view of the keycap according to an embodiment of the invention; and

FIG. 3 is a cross-sectional view of the keycap according to an embodiment of the invention.

### DESCRIPTION OF THE PREFERRED EMBODIMENTS

The aforementioned and other objectives and advantages of this disclosure will become clearer in light of the following detailed description of an illustrative embodiment of this invention described in connection with the drawings.

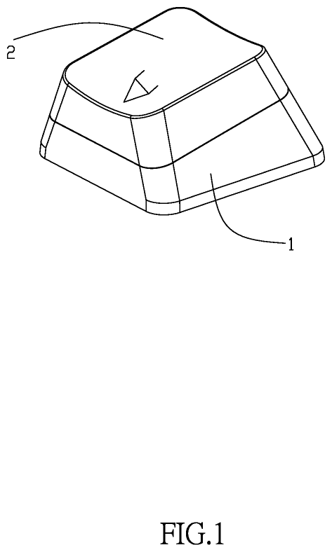

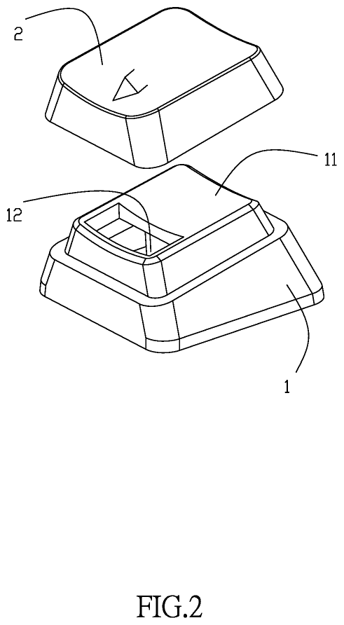

As shown in FIG. 1 to FIG. 3, the disclosed keycap for a luminous keyboard according to an embodiment of the invention includes a base 1 and a cap 2 made of a transparent or translucent material. The base 1 is provided with a first stage 11 whose top surface is transparent. The cap 2 covers the first stage 11, and is fixedly connected to the base 1. The cap 2 is provided with a light-shielding layer. A light-transmitting area is formed on the surface of the light-shielding layer opposite to the first stage 11 by laser engraving. The light-transmitting area has the shape of a character or pattern, as shown by the character ‘A’ in FIG. 1 and FIG. 2. Two or more light-transmitting areas can be formed on a keycap to satisfy the needs of different functional identifications of the keycap.

To install, the keycap covers a light source. When the light source is on, light emits toward the top surface of the first stage 11 of the base 1. Since the cap 2 is provided with a light-shielding layer, the light is prevented from escaping from the cap 2, but only from the light-transmitting area, so that the keycap is in a light-emitting state, which is convenient for the user to quickly identify each keycap in a dark environment. This is convenient for operations. The light-transmitting area is set by the laser engraving technology to have the shape of a character or pattern, so that it cannot be easily erased. In comparison with the prior art, the lifetime of the disclosed cap is longer. The light-shielding layer on the cap 2 can be set to a different color from that of the base 1, enabling the keycaps to have more colors and abundant styles. This can meet the needs of different users.

In this embodiment, the cap 2 and the base 1 are fixedly connected by means of dispensing or ultrasonic welding, so that the cap 2 and the base 1 are connected more firmly and reliably than the conventional method of clamping. The connection between the cap 2 and the base 1 is prevented from breaking off by vibrations during the transportation of keycaps. It is found that connecting the cap 2 and the base 1 by dispensing or ultrasonic welding also solves the problem of light leakage from the junction between the cap 2 and the base 1. The keycaps on the keyboard are more layered, rendering a better visual effect and significantly improving user's experience. When using the dispensing method, glue is applied onto the base 1 through a dispenser. The glue can block the light from emitting and connect the cap 2 to the base 1, forming a keycap. When using the ultrasonic welding method, the cap 2 is capped on the base 1 and then ultrasonically welded into one piece, so that the cap 2 and the base 1 are seamlessly connected to avoid light leakage and to form a keycap.

In an embodiment, a light-shielding layer is preferably disposed on the inner surface of the cap 2, and the light-transmitting area is correspondingly disposed on the inner top surface of the light-shielding layer. Thus, the light-transmitting area is not in direct contact with user's fingers. Consequently, the light-transmitting area in the shape of a character or pattern never fades or wears away. The touch is better. It solves the problem that the user directly touches the characters or patterns, so that the characters or patterns can be rubbed off.

In this embodiment, a weakening layer for weakening light is further disposed on the surface of the light-shielding layer, so that the transmitted light looks softer and more uniform. The user does not suffer from strong glare due during usage. It protects user's eyes, and is safer and more reliable for the human body.

Based on the above-mentioned embodiment, the top surface of the first stage 11 of the base 1 is formed with a light-transmitting hole 12, as shown in FIG. 2. The base 1 can be made of a transparent or opaque material of any color. The base 1 can even be made to have different colors on a keyboard, making it look more beautiful, have more combinations, and present a richer structure. It can meet different aesthetic needs of the user. The entire keyboard is thus luminous and more colorful. Preferably, the base 1 is made of an opaque material so that light is only emitted from the light-transmitting hole. This prevents light of two adjacent keycaps from interfering with each other or leaking from the base 1 to irritate user's eyes. The structure is thus safer.

Of course, without forming a hole in the embodiment, the base 1 can be produced by using a transparent material of any color. The embodiment can also adopt a two-color injection molding method. The first stage 11 of the base 1 is made of a transparent material of any color. The periphery of the base 1 is made of a transparent or opaque material of any color by injection molding. This can satisfy different needs of the user, making the structure more flexible.

Based upon the above-mentioned embodiment, another embodiment of the invention is that the outer surface of the cap 2 is disposed with a light-shielding layer and a wear-resistant layer. The wear-resistant layer is disposed on the light-shielding layer to increase the hardness of the light-shielding layer, thereby achieving the purposes of wear resistance and corrosion resistance. The light-transmitting area in engraved to have the shape of a character or pattern is thus unlikely to be erased by the user or corroded due to sweat or other liquid. This extends the lifetime of the keycaps.

In this embodiment, the weakening layer is disposed between the outer surface of the cap 2 and the light-shielding layer to achieve the effect of weakening light, thereby making the user more comfortable in use.

As shown in FIGS. 1 to 3, the method for manufacturing the above-mentioned keycap includes the following steps:

S1: injection molding the cap 2 using a transparent or translucent material, injection molding the base 1 with the first stage 11, and setting the top surface of the first stage 11 transparent;

S2: in order to quickly solidify and firmly adhere the light-shielding paint on the inner surface of the cap 2, spraying a paint of white or some other color on the inner surface of the cap 2 and then spraying the light-shielding paint of silver, black or some other light-shielding paint, thereby forming a light-shielding layer; or spraying a white primer for weakening light on the outer surface of the cap 2, and then spraying the light-shielding paint of silver, black or some other light-shielding paint, thereby forming a light-shielding layer;

S3: removing part of the paint on the light-shielding layer by laser engraving according to a desired character or pattern, thereby forming a light-transmitting area in the shape of a character or a pattern, such as the character ‘A’ shown in FIG. 1 and FIG. 2;

S4: spraying a pearl white paint on the inner surface of the cap 2 to form a weakening layer; or spraying a UV paint on the outer surface of the cap 2 to form a wear-resistant layer; and

S5: covering the cap 2 onto the first stage 11 of the base 1, and then fixedly connecting the cap 2 and the base 1 by means of dispensing or ultrasonic welding.

In the actual use of the keycap made according to this embodiment, it is found that the light-transmitting area in the shape of a character or a pattern presents colorful light, so that the keycap looks more colorful. Through a microscope, it is found that some fine particles exist in the light-transmitting area. A careful analysis shows that these fine particles are the color paint sprayed in the first time. It is then concluded that the colorful light emitted from the light-transmitting area is the result of optical scattering, deflection and absorption by the particles.

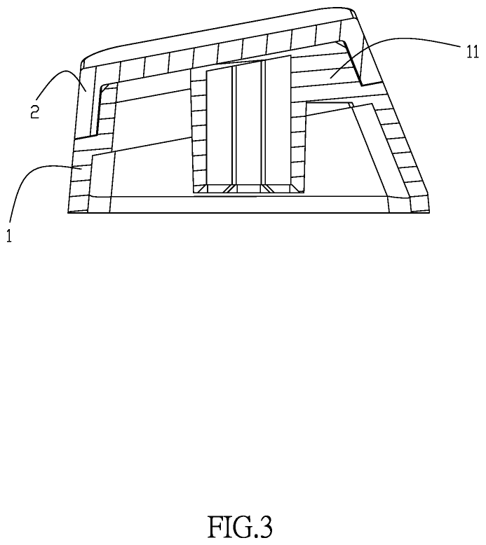

Based on the above embodiment, as shown in FIG. 3, an opening is further hollowed out on the first stage 11 of the base 1, thereby forming the light-transmitting hole 12.

Using the disclosed keycap and the manufacturing method thereof, the user can use the keyboard accurately and quickly even in a dark environment. The light-transmitting area with characters or patterns on the keycap is not likely to be rubbed or erased. The lifetime of the keycap is thus extended. The combination of the cap 2 and the base 1 has a crystal shape to enhance the visual effect of the entire keyboard, rendering a product that is more beautiful, comfortable, and feels better.

In addition, the light-shielding layer on the cap 2 and the base 1 of the invention can be set in different colors, so that the keycaps are presented in multiple colors, the style is more abundant, the structure is more beautiful, satisfying the needs of different users. The invention also solves the problem of the boring monochromic color of traditional keycaps. Moreover, the cap 2 and the base 1 are fixedly connected by means of dispensing or ultrasonic welding, which can effectively solve the problem of leakage of light through the junction in between. Therefore, the keycaps on the whole keyboard are more layered with a better visual effect. This can significantly improve the user's operating experience.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

1. A keycap for a luminous keyboard, comprising a base and a cap made of a transparent material, wherein
the base is provided with a first stage whose top surface is transparent;
the cap covers the first stage and is fixedly connected to the base; and
the cap is provided with a light-shielding layer, and a light-transmitting area is engraved by laser on the side of the light-shielding layer opposite to the first stage.

2. The keycap of claim 1, wherein the cap and the base are fixedly connected by dispensing or ultrasonic welding.

3. The keycap of claim 1, wherein a light-shielding layer is provided on the inner surface of the cap.

4. The keycap of claim 3, wherein a weakening layer for weakening light is formed on the surface of the light-shielding layer.

5. The keycap of claim 1, wherein the outer surface of the cap is provided with a light-shielding layer and a wear-resistant layer, with the wear-resistant layer disposed on the light-shielding layer.

6. The keycap of claim 5, wherein a weakening layer for weakening light is disposed between the outer surface of the cap and the light-shielding layer.

7. The keycap of claim 1, wherein the top surface of the first stage on the base is provided with a light-transmitting hole.

8. A method of manufacturing the keycap of claim 1, comprising the steps of:
S1: injection molding a cap using a transparent or translucent material, and injection molding a base having a first stage, with the top surface of the first stage being transparent;
S2: spraying a paint of white or other color on the inner surface of the cap, and then spraying a light-shielding paint of silver, black or some other light-shielding color on the inner surface of the cap, forming a light-shielding layer; or spraying a white primer for weakening light on the outer surface of the cap to form a weakening layer, and then spraying on the outer surface of the cap with a paint of silver, black or other light-shielding color, forming a light-shielding layer;
S3: removing part of the paint on the light-shielding layer by laser engraving according to a desired character or pattern, thereby forming a light-transmitting area in the shape of a character or pattern;
S4: spraying a paint of pearl white on the inner surface of the cap to form a weakening layer; or spraying a UV paint on the outer surface of the cap to form a wear-resistant layer; and
S5: covering the cap on the first stage of the base, and fixedly connecting the cover onto the base by dispensing or ultrasonic welding.

9. The method of claim 8, wherein the first stage of the base is formed with an opening as the light-transmitting hole.
